(19) United States
(12) Patent Application Publication
(10) Pub. No.: US 2017/0132988 A1
(43) Pub. Date: May 11, 2017

(54) CONTROL METHOD AND DEVICE FOR CHANGING BRIGHTNESS

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Xianshan WANG, Beijing (CN)

(21) Appl. No.: 15/245,026

(22) Filed: Aug. 23, 2016

Related U.S. Application Data
(63) Continuation of application No. PCT/CN2016/089118, filed on Jul. 7, 2016.

(30) Foreign Application Priority Data
Nov. 6, 2015 (CN) 201510758257.8

(51) Int. Cl. G09G 5/10

(52) U.S. Cl. CPC G09G 5/10; G09G 2320/0626; G09G 2320/0247

(57) ABSTRACT

An embodiment of the present disclosure discloses a control method and a control device for changing brightness. The method comprises the following steps of: during the brightness changing process of the display screen, determining first hardware backlight data before the changing and second hardware backlight data after the changing according to system brightness before and after the changing; successively changing the first hardware backlight data according to a unit backlight value to update the first hardware backlight data until the first hardware backlight data being updated to the second hardware backlight data; and successively changing the brightness of the display screen according to the updated first hardware backlight data until the brightness of the display screen reaches the system brightness after the changing.

### CROSS-REFERENCE TO RELATED APPLICATIONS

This application is a continuation of International Application No. PCT/CN2016/089118, filed on Jul. 7, 2016, which is based upon and claims priority to Chinese Patent Application No. 201510758257.8, entitled “CONTROL METHOD AND DEVICE FOR CHANGING BRIGHTNESS”, filed to State Intellectual Property Office of The P.R.C on Nov. 6, 2015, the entire contents of which are incorporated herein by reference.

### TECHNICAL FIELD

The present disclosure generally relates to the technical field of display, and more particularly, to a control method and a control device for changing brightness.

### BACKGROUND

With the rapid development of liquid crystal display technology, liquid crystal display gradually replaces cathode-ray tube display and becomes the mainstream of display.

Generally, LCD is controlled by backlight brightness. Different hardware chips support different backlight control modes. Take an android system for an example, the default backlight levels of the present android system are 0-255, including only 256 levels in total. However, the backlight levels supported by hardware are not necessarily 256 levels while using the backlight control mode. For example, the backlight levels supported by hardware chips are 0-4095, including 4096 levels in total. When an android system layer sets a backlight value, the value needs to be mapped from 0-255 levels to 0-4095 levels at the driver layer and then set into the register of hardware chips. Therefore, when the backlight of the system layer is changed by one level, the backlight of the driver layer is changed by 16 levels equivalently. When backlight is in a high-brightness area, human eyes are not very sensitive to the change of brightness and are not uncomfortable with the change of the backlight. However, when the backlight is in a low-brightness area, human eyes are sensitive to the change of brightness. When the backlight is changed, human eyes will sense the phenomenon of flicker and are liable to fatigue.

Obviously, the backlight display of LCD has the problem of flicker.

### SUMMARY

The technical problem to be solved by the present disclosure is to provide a control method and a device for changing brightness to avoid the phenomenon of flicker of the display screen caused by the hopping configuration of the backlight levels of hardware.

According to one aspect of the present disclosure, the embodiments of the present disclosure disclose a control method for changing brightness, including the following steps:

during a brightness changing process of the display screen, determining a first hardware backlight data before the changing and a second hardware backlight data after the changing according to system brightness before and after the changing;

successively changing the first hardware backlight data according to a unit of the backlight value to update the first hardware backlight data until the first hardware backlight data being updated to the second hardware backlight data; and

successively changing the brightness of the display screen according to the updated first hardware backlight data until the brightness of the display screen reaches the system brightness after the changing.

Correspondingly, according to another aspect of the present disclosure, the examples of the present disclosure further disclose a control device for changing brightness, including: at least one processor; and a memory communicably connected with the at least one processor for storing instructions executable by the at least one processor, wherein execution of the instructions by the at least one processor causes the at least one processor to:

during the brightness changing process of the display screen, determine a first hardware backlight data before the changing and a second hardware backlight data after the changing according to system brightness before and after the changing;

successively change the first hardware backlight data according to a unit of the backlight value to update the first hardware backlight data until the first hardware backlight data is updated to the second hardware backlight data;

successively change the brightness of the display screen according to the updated first hardware backlight data until the brightness of the display screen reaches the system brightness after the changing.

According to another aspect of the present disclosure, a computer program, which includes a computer readable code, is provided. When the computer readable code is operated on an electronic device, as a result, the electronic device will carry out the aforementioned control method for changing brightness.

According to one further aspect of the present disclosure, a computer readable medium is provided, in which the aforementioned computer program is stored.

Compared with the prior art, the embodiments of the present disclosure include the following advantages:

the embodiments of the present disclosure can, during brightness change process of the display screen, successively change the first hardware backlight data according to the unit of the backlight value to update the first hardware backlight data, and successively change the brightness of the display screen according to the updated first hardware backlight data until the brightness of the display screen reaches the system brightness after the changing. That is, the backlight levels of hardware chips are successively changed by virtue of the unit of the backlight value, so as to solve the problem of flicker of the display screen caused by the hopping configuration of the backlight levels of hardware and enhance the user experience.

To understand the technical means of the present disclosure more clearly, the present disclosure can be implemented according to the specification. In addition, to make the mentioned and other purposes, characteristics and advantages of the present disclosure obvious and understandable, the specific implementation methods of the present disclosure are illustrated below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of an embodiment of a control method for changing brightness of the present disclosure.

FIG. 2 is a step flow diagram of a preferred embodiment of a control method for changing brightness of the present disclosure.

FIG. 3 is a structure diagram of an embodiment of a control device for changing brightness of the present disclosure.

FIG. 4 is a structure diagram of a preferred embodiment of a control device for changing brightness of the present disclosure.

FIG. 5 schematically illustrates a block diagram of an electronic device which is used for carrying out the method of the present disclosure.

FIG. 6 schematically illustrates a storage cell used to keep or carry program codes that carry out the method according to the present disclosure.

### DETAILED DESCRIPTION

To make the purposes, the technical schemes and the advantages of the embodiments of the present discloser clearer, the technical schemes of the embodiments of the present disclosure are described clearly and completely in combination with the drawings of the embodiments of the present disclosure. Obviously, the described embodiments are a part of the embodiments of the present disclosure, rather than all the examples. Based on the embodiments in the present disclosure, the other embodiments acquired by those skilled in the art without paying any creative work all belong to the scope sought to be protected by the present disclosure.

When the backlight is in a low-brightness area, human eyes are sensitive to the brightness change and will sense the phenomenon of display screen flickers when the backlight changes. That is, the display screen has the flickering problem when the brightness changes.

To solve the above technical problem, one of the core designs of the embodiments of the present disclosure lies in that the hardware backlight data are successively changed by the unit of the backlight value and the brightness of the display screen is successively changed according to the changed hardware backlight data until the brightness of the display screen reaches the system brightness after the changing. That is, the backlight levels of hardware chips are successively changed by the unit of the backlight value to avoid the hopping configuration of the backlight levels of hardware chips, so as to solve the flickering problem of the display screen.

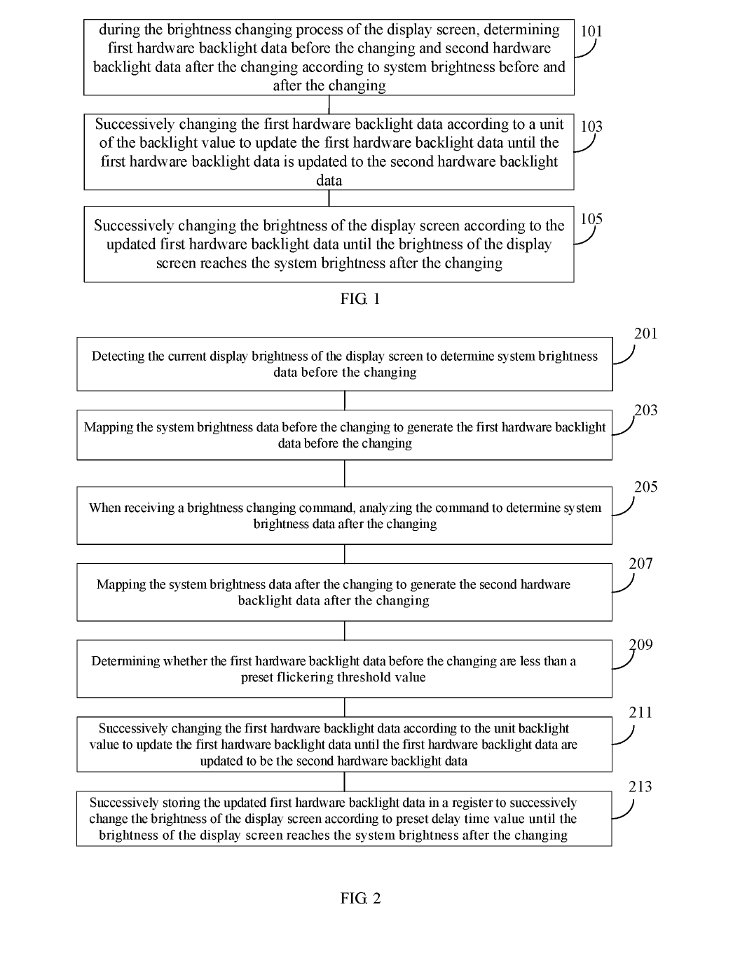

Referring to FIG. 1, a step flow diagram of an embodiment of a control method for changing brightness of the present disclosure is illustrated, specifically including the steps as follows.

Step 101, during brightness change process of the display screen, the first hardware backlight data before the changing and the second hardware backlight data after the changing is determined according to the system brightness before and after the changing.

In fact, the backlight levels supported by the display system are not necessarily the same as the backlight levels supported by hardware. Take the android system as an example, the backlight levels supported by the present android system are 0-255, including 256 levels in total. It is assumed that the backlight levels supported by hardware chips are 0-4095, including 4096 levels in total. When a backlight value is set in the system layer, the system backlight value needs to be mapped from 0-255 levels to 0-4095 levels in the driver layer and then set in the register of hardware chips. Therefore, according to the correspondence between the backlight levels supported by the system and the backlight levels supported by hardware, the hardware backlight level (i.e. hardware backlight data) which corresponds to the system backlight value (i.e. system brightness) can be determined.

Normally, users can change the display brightness of the display screen by setting the backlight value (i.e. brightness value) of the system. For example, in the “display” of the “settings” of smartphones, the brightness value of the system can be changed when the brightness progress bar is pulled. Pulling the brightness progress bar corresponds to inputting a brightness changing command in response to the brightness changing command, i.e., the display brightness of the display screen needs to be changed. Specifically, the current system brightness of the display screen (i.e. the system brightness before brightness change) can be determined by detecting the current display brightness of the display screen and the current backlight level which hardware chips correspond to can be further determined. That is, the hardware backlight data before the changing can be determined according to the system brightness before the changing and can be marked as the first hardware backlight data. When the brightness changing command is received, the brightness changing command is analyzed to determine the display brightness required by the display screen after the brightness change (i.e. the system brightness after the changing). Thereby, the hardware backlight data after the changing can be determined and can be marked as the second hardware backlight data. For example, the system brightness after the changing can be determined according to the cursor position of the brightness progress bar and the second hardware backlight data after the changing can be further determined.

In a preferred embodiment of the present disclosure, the step of determining the first hardware backlight data before the changing and the second hardware backlight data after the changing according to the system brightness before and after the changing can include the substeps as follows.

Substep 10101, detecting the brightness currently displayed by the display screen to determine the system brightness data before the changing.

Substep 10103, mapping the system brightness data before the changing to generate the first hardware backlight data before the changing.

Substep 10105, when receiving a brightness changing command, analyzing the command to determine the system brightness data after the changing.

Substep 10107, mapping the system brightness data after the changing to generate the second hardware backlight data after the changing.

Step 103, successively changing the first hardware backlight data according to the unit of the backlight value to update the first hardware backlight data until the first hardware backlight data are updated to the second hardware backlight data.

As the hopping configuration of backlight levels of hardware chips can result in the flicker phenomenon of the display screen. Therefore, during the bright change process of the display screen, the first hardware backlight data can be successively changed according to the unit of the backlight value until the first hardware backlight data are updated to the second hardware backlight data. Specifically, during the bright change process, i.e., when the first hardware backlight data are different from the second hardware backlight data, the backlight levels of hardware chips can be gradually changed by successively changing the backlight levels of hardware chips only by one backlight level every time, which means that the first hardware backlight data are successively changed according to the unit of the backlight value to update the first hardware backlight data. When the system brightness is lowered, i.e., when the first hardware backlight data are lower than the second hardware backlight data, the first hardware backlight data are successively reduced according to the unit of the backlight value until the first hardware backlight data are reduced to the second hardware backlight data. For example, the first hardware backlight data is 640, the second hardware backlight data is 624 and the unit of the backlight value is 1; the first hardware backlight data 640 is successively reduced by the unit of the backlight value 1 until the first hardware backlight data is reduced to 624. That is, the first hardware backlight data 640 is reduced to 639 at the first time, the first hardware backlight data 639 is reduced to 638 at the second time, the first hardware backlight data 638 is reduced to 637 at the third time and so on until the first hardware backlight data becomes 624, which means that the first hardware backlight data are updated to the second hardware backlight data. When the system brightness is heightened, i.e., when the first hardware backlight data are higher than the second hardware backlight data, the first hardware backlight data are successively increased according to the unit of the backlight value until the first hardware backlight data are increased to the second hardware backlight data.

Certainly, it can be set that when the system brightness is heightened, the first hardware backlight data are lower than the second hardware backlight data; and when the system brightness is lowered, the first hardware backlight data are higher than the second hardware backlight data. The embodiments of the present disclosure do not make any limitation to this. For convenient description, the embodiments of the present disclosure are uniformly described under the condition that when the system brightness is heightened, the first hardware backlight data are higher than the second hardware backlight data; and when the system brightness is lowered, the first hardware backlight data are lower than the second hardware backlight data.

Step 105, successively changing the brightness of the display screen according to the updated first hardware backlight data until the brightness of the display screen reaches the system brightness after the changing.

In the embodiments of the present disclosure, the first hardware backlight data correspond to the display brightness currently displayed by the display screen. That is, the first hardware backlight data correspond to the display brightness actually displayed by the display screen. Therefore, the brightness of the display screen can be successively changed according to the updated first hardware backlight data until the brightness of the display screen reaches the brightness after the changing.

As a specific embodiment of the present disclosure, it is assumed that the system brightness of the display screen before the changing is 40 and the system brightness 40 corresponds to the hardware backlight data 640. If the display brightness needs to be displayed by the display screen becomes 39 after the brightness change, which means the system brightness becomes 39 after the changing, the second hardware backlight data is 624. The first hardware backlight data 640 is successively reduced according to the unit of the backlight value 1. That is, the first hardware backlight data changes from 640 to 639, then to 638 and so on until the first hardware backlight data becomes 624. During the change of the first hardware backlight data, the display brightness actually displayed by the display screen is successively changed according to the update of the first hardware backlight data. That is, it is changed from the brightness of the display screen to which the first hardware backlight data 640 corresponds, to the brightness of the display screen to which the first hardware backlight data 639 corresponds, and then to the brightness of the display screen to which the first hardware backlight data 638 corresponds and so on, until to the brightness of the display screen to which the first hardware backlight data 624 corresponds. That is, the brightness of the display screen reaches the system brightness 39 after the changing.

In another preferred embodiment of the present disclosure, successive changing the brightness of the display screen according to the updated first hardware backlight data may successively store the updated first hardware backlight data in the register so as to successively change the brightness of the display screen according to the preset delay time value.

To sum up, During the brightness change process of the display screen, the embodiments of the present disclosure can successively change the first hardware backlight data according to the unit of the backlight value to update the first hardware backlight data and successively change the brightness of the display screen according to the updated first hardware backlight data until the brightness of the display screen reaches the system brightness after the changing. That is, the backlight levels of hardware chips are successively changed by the unit of the backlight value so as to solve the problem of flicker of the display screen caused by the hopping of backlight levels of hardware chips and increase the user experience.

In a preferred embodiment of the present disclosure, the control method for changing brightness may include the steps as follows.

S1, determining whether the first hardware backlight data before the changing is lower than a preset flickering threshold value.

S2, performing the step of successively changing the first hardware backlight data according to the unit of the backlight value when the first hardware backlight data before the changing is lower than the flickering threshold value.

In order to make those skilled in the art have a better understanding of the embodiments of the present disclosure, the embodiments of the present disclosure are described in combination with the preferred embodiment.

Referring to FIG. 2, a step flow diagram of a preferred embodiment of a control method for changing brightness of the present disclosure is illustrated, specifically including the steps as follows.

Step 201, detecting the display brightness currently displayed by the display screen to determine the system brightness data before the changing.

In specific realization, the brightness actually displayed by the display screen may be determined by detecting the brightness currently displayed by the display screen, i.e. determining the system brightness data before the changing. For example, the display brightness currently displayed by the display screen is detected by an imaging brightness meter and the system brightness data before the changing is determined to be 40. It needs to explain that the instrument of brightness can include, but are not limited to any one or several types of an imaging brightness meter, a shading cylinder brightness meter, a CCD pixel grey level measuring system, a CCD imaging brightness meter and so on. The embodiments of the present disclosure do not make any definition to this.

Certainly, a detecting software or a detecting system for the system brightness of the display screen can be adopted for detection. The embodiments of the present disclosure do not make any definition to this.

Step 203, mapping the system brightness data before the changing to generate the first hardware backlight data before the changing.

Actually, different system brightness corresponds to different backlight levels of hardware chips. According to the correspondence of the backlight levels supported by the system and the backlight levels supported by hardware, the system brightness data before the changing can be mapped to generate the first hardware backlight data before the changing.

As a specific embodiment of the present disclosure, the backlight levels supported by hardware chips are 0-4095, including 4096 levels in total; the backlight levels supported by the display system are 0-255, including 256 levels in total. When the system brightness data is 40, the first hardware backlight data can be determined to be 640 by mapping the system brightness data 40, i.e. mapping the system brightness data 40 from 0-255 to the 0-4095 areas. The mapping can be interpreted as a computational process (40*16=640).

Step 205, when receiving a brightness changing command, analyzing the command to determine the system brightness data after the changing.

Step 207, mapping the system brightness data after the changing to generate the second hardware backlight data after the changing.

Normally, users can change the brightness displayed by the display screen by setting a system brightness value. Specifically, the user sets the system brightness value, for example, inputting 39 into the dialog box for setting the system brightness value, which corresponds to sending a brightness changing command which includes the system brightness data after the changing to the display screen system. Correspondingly, when the display screen system receives the brightness changing command, the display screen system can acquire the system brightness data in the brightness changing command by analyzing the brightness changing command. That is, it is determined that the system brightness data is 39 after the changing. By mapping the system brightness data 39 after the changing, it may be determined that the second backlight data is 624.

Certainly, the embodiments of the present disclosure can perform step 201 and step 203 only when the brightness changing command is received. The embodiments of the present disclosure do not make any limitation to this.

Step 209, determining whether the first hardware backlight data before the changing is lower than the preset flickering threshold value.

Actually, the flickering threshold value can be preset according to the brightness value of the flickering sensed by human. When the backlight (i.e. the brightness value) of the display screen is in a high-brightness area and that is, when the first hardware backlight data are higher than the flickering threshold value, human eyes are not very sensitive to the brightness change and are not uncomfortable with the backlight change; when the backlight of the display screen is in a low-brightness area and that is, when the first hardware backlight data are lower than the flickering threshold value, human eyes are sensitive to the brightness change and will sense the phenomenon of flicker when the backlight changes. When the first hardware backlight data before the changing are higher than the flickering threshold value and that is, when the backlight (i.e. the brightness value) of the display screen is in a high-brightness area, the brightness of the display screen can be changed according to the existing technical schemes or the technical schemes of the present disclosure, as the embodiments of the present disclosure do not make any limitation to this. Whether the display screen will have the phenomenon of flicker will be determined by determining whether the first hardware backlight data before the changing are lower than the preset flickering threshold value, i.e. determining whether the backlight of the display screen is in a low-brightness area. When the first hardware backlight data are lower than the flickering threshold value, i.e., the backlight of the display screen is in the low-brightness area, step 211 can be performed to avoid the phenomenon of flicker of the display screen.

Step 211, successively changing the first hardware backlight data according to the unit of the backlight value to update the first hardware backlight data until the first hardware backlight data is updated to the second hardware backlight data.

In a preferred embodiment of the present disclosure, the step of successively changing the first hardware backlight data according to the unit of the backlight value can include the following substeps:

Sub-step 21101, determining whether the first hardware backlight data are lower than the second hardware backlight data.

Substep 21103, successively reducing the first hardware backlight data according to the unit of the backlight value.

Sub-step 21105, successively increasing the first hardware backlight data according to the unit of the backlight value.

When the first hardware backlight data are different from the second hardware backlight data, the brightness displayed by the display screen needs to be changed. Whether the brightness of the display screen needs to be lowered can be determined by determining whether the first hardware backlight data is lower than the second hardware backlight data, i.e. determining whether the brightness currently displayed by the display screen is lower than the brightness needs to be displayed by the display screen after the changing. When the brightness of the display screen needs to be lowered and that is, when the first hardware backlight data are lower than the second hardware backlight data, substep 21103 is performed until the first hardware backlight data are updated to the second hardware backlight data; and when the brightness of the display screen needs to be heightened and that is, when the first hardware backlight data are not lower than the second hardware backlight data, substep 21105 is performed until the first hardware backlight data are updated to the second hardware backlight data.

Step 213, successively storing the updated first hardware backlight data in the register to successively change the brightness of the display screen according to the preset delay time value until the brightness of the display screen reaches the system brightness after the changing.

During the brightness change process of the display screen, storing the updated first hardware backlight data in the hardware register every time may delay some time to improve user experience. For example, during lowering the backlight process of the display screen and heightening the display, they are delayed for 2 ms and 1 ms respectively, so that when the backlight of the display screen is lowered, the time delay is longer and when the backlight of the display screen is heightened, the time delay is shorter. Thereby, user experience is further improved.

In order to make a detailed introduction to the embodiments of the present disclosure, the present disclosure is exemplified with the combination of the following specific algorithm. In the embodiments of the present disclosure, the corresponding backlight levels are different since the chips are different, thus the backlight levels may be determined by the chips actually used. For example, if the PMI8994 chip of Qualcomm is adopted, the backlight level supported by “bl_ctrl_wled” provided by the chip is 0-4095.

As a specific embodiment of the present disclosure, it is assumed that when the change of the system backlight value of the display screen is lower than 50, the display screen flickers if the system backlight value is changed. The backlight levels supported by the system are 0-256, the backlight levels supported by hardware chips are 0-4095 and the backlight value 50 of the system becomes 800 (50*16=800) after being mapped from 0-255 to 0-4095 area. That is, the preset flickering threshold value is 800. When the system backlight value is set to be lower than 50 and that is, lower than 800 after mapping, the array a[i] is used to record continuous backlight changes and the initial value of i is preset to be 0. Wherein, hardware backlight data can be denoted by temp, a[0] records the first hardware backlight data and a[1] records the second hardware backlight data. The whole implementation algorithm is as follows:

```
    i = 0;//  the initial value of i being 0.
    if (temp < 800) {
    a[i] = temp;
    i++;  //recording two continuous changes of the backlight value.
    if (i > 1) { //carrying out the algorithm only in case of
continuous backlight value changes.
    if (a[i−1] < a[i−2]) { //when brightness being lowered.
            for (; a[i−1] != a[i−2]; a[i−2]−−) { //successively
changing the brightness value with the unit being 1.
    pdata->set_backlight(pdata, a[i−2]);
                usleep(2000);  //time delay of 2ms.
            }
    a[i−2] = a[i−1];
      i−−; //dropping a[1] value to prepare for the next record a[1].
    } else { //when brightness being lowered
        for (; a[i−1] != a[i−2]; a[i−2]++) { //successively changing
the brightness value with the unit being 1.
            pdata->set_backlight(pdata, a[i−2]);
            usleep(1000);  // time delay of 1 ms
        }
        a[i−2] = a[i−1];
        i−−;  // dropping a[1] value to prepare for the next record a[1].
    }
      } else {
        pdata->set_backlight(pdata, temp);
        }
    } else {
          i = 0;
          pdata->set_backlight(pdata, temp);
    }
```

Wherein, the symbol “//” can be used to analyze algorithmic statements. For example, “i=0;// the initial value of i being 0.” can express that the statement of “i=0” meaning the initial value of i being 0. “if (temp<800)” can be interpreted as “if the hardware backlight data which the brightness currently displayed by the display screen corresponds to is less than the flickering threshold value”, which corresponds to determining whether the first hardware backlight data before the changing are lower than the preset flickering threshold value. When the hardware backlight data which brightness currently displayed by the display screen corresponds to is less than the flickering threshold value, the steps of a[i]=temp and i++ are carried out. That is, the array [i] is used to record continuous backlight changes, which corresponds to determining the first hardware backlight data and the second hardware backlight data.

“if (i>1)” can be interpreted as “when the brightness changing command is received”.

“if (a[i−1]<a[i−2])” corresponds to determining whether the first hardware backlight data are lower than the second hardware backlight data. When the first hardware backlight data are lower than the second hardware backlight data, the step of successively reducing the first hardware backlight data according to the unit of the backlight value is carried out until the first hardware backlight data are updated to the second hardware backlight data, i.e., performing the step of for (; a[i−1] !=a[i−2]; a[i−2]--) {pdata->set_backlight(pdata, a[i−2]); usleep(2000);}t. Wherein, pdata->set_backlight(pdata, a[i−2]) can be interpreted as “setting the updated first hardware backlight data into the register of hardware chips, i.e. successively storing the updated first hardware backlight data into the register.”

“a[i−2]=a[i−1]” shows that after the first hardware backlight data which change continuously are successively set into the register, a[0] which records the first hardware backlight data is dropped and the value of a[1] is reserved in a[0], which corresponds to updating the first hardware backlight data to the second hardware backlight data.

“for (; a[i−1] !=a[i−2]; a[i−2]++)” corresponds to successively increasing the first hardware backlight data according to the unit of the backlight value until the first hardware backlight data are updated to the second hardware backlight data.

In the embodiments of the present disclosure, the updated first hardware backlight data can be stored by the register and the brightness of the display screen is gradually changed, so that the system software codes will not consider the change of more softwares and system software codes do not excessively depend on hardware. That is, different hardware chips can use one set of code software mechanism uniformly to avoid the troublesome of maintaining a plurality of sets of codes and save the compiling switch which is required before the code operation to control the compiling complexity of the codes, so as to reduce the workload for development and reduce the labor cost.

In addition, the embodiments of the present disclosure may gradually change the brightness of the display screen according to the preset delay time, so that when the backlight of the display screen is lowered, the delay time is longer and when the backlight of the display screen is heightened, the delay time is shorter. Thereby, user experience is further improved.

It needs to explain that the method examples are described as a series of movement combination for brief description, but those skilled in the art should know that the embodiments of the present disclosure are not limited by the order of the described movement, since some steps can adopt other order or be performed simultaneously according to the embodiments of the present disclosure. Secondly, those skilled in the art should also know that all the embodiments in the description belong to preferred embodiments and the involved movements are not necessary for the embodiments of the present disclosure.

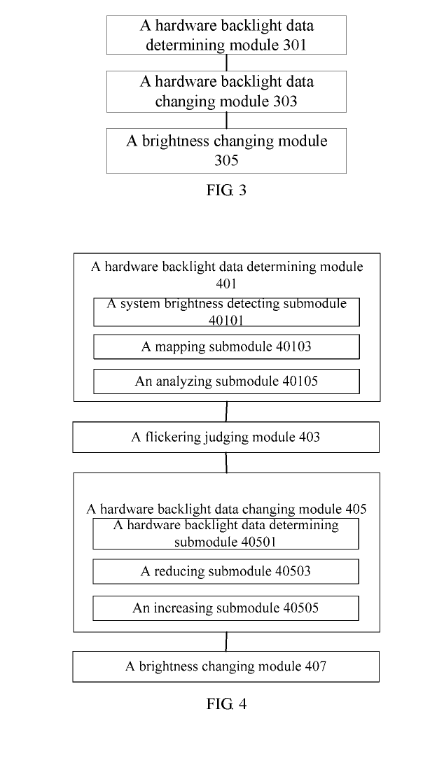

Referring to FIG. 3, a structure diagram of the embodiment of a control device for changing brightness of the present disclosure is illustrated, specifically including the following modules:

a hardware backlight data determination module 301 for determining the first hardware backlight data before the changing and the second hardware backlight data after the changing according to the system brightness before and after the brightness change process of the display screen;

a hardware backlight data change module 303 for successively changing the first hardware backlight data according to the unit of the backlight value to update the first hardware backlight data until the first hardware backlight data are updated to the second hardware backlight data;

and a brightness change module 305 for successively changing the brightness of the display screen according to the updated first hardware backlight data until the brightness of the display screen reaches the system brightness after the changing.

Referring to FIG. 4, a structure diagram of a preferred embodiment of a control device for changing brightness of the present disclosure is illustrated, specifically including the following modules:

a hardware backlight data determination module 401 which for determining the first hardware backlight data before the changing and the second hardware backlight data after the changing according to the system brightness before and after the brightness change process of the display screen;

In a preferred embodiment of the present disclosure, the hardware backlight data determination module 401 can include the following submodules:

a system brightness detection submodule 40101 for detecting the brightness currently displayed by the display screen to determine the system brightness data before the changing;

a mapping submodule 40103 for mapping the system brightness data before the changing to generate the first hardware backlight data before the changing and mapping the system brightness data after the changing to generate the second hardware backlight data after the changing;

an analyzing submodule 40105 for analyzing the brightness changing command when a brightness changing command is received to determine the system brightness data after the changing.

a flicker judgement module 403 for determining whether the first hardware backlight data before the changing are lower than the preset flickering threshold value and triggering the hardware backlight data change module 405 when the first hardware backlight data before the changing are lower than the flickering threshold value;

a hardware backlight data change module 405 for successively changing the first hardware backlight data according to the unit of the backlight value to update the first hardware backlight data until the first hardware backlight data are updated to the second hardware backlight data;

In another preferred embodiment of the present disclosure, the hardware backlight data change module 405 can include the following submodules;

a hardware backlight data judgement submodule 40501 for determining whether the first hardware backlight data are lower than the second hardware backlight data;

a reduction submodule 40503 for successively reducing the first hardware backlight data according to the unit of the backlight value when the first hardware backlight data are lower than the second hardware backlight data until the first hardware backlight data are updated to the second hardware backlight data;

an increasing submodule 40505 for successively increasing the first hardware backlight data according to the unit of the backlight value when the first hardware backlight data are not lower than the second hardware backlight data until the first hardware backlight data are updated to the second hardware backlight data.

a brightness change module 407 specifically for successively storing the updated first hardware backlight data in the register to successively change the brightness of the display screen according to the preset delay time value.

With respect to the device embodiments, which are basically similar to the method embodiments, the description is relatively simple. Please refer to the description of the method embodiments for the relevance.

All the embodiments in the specification are described progressively and the emphasis explained by each embodiment is the difference from other embodiments. It is capable to refer to each other for the similarities of the embodiments.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

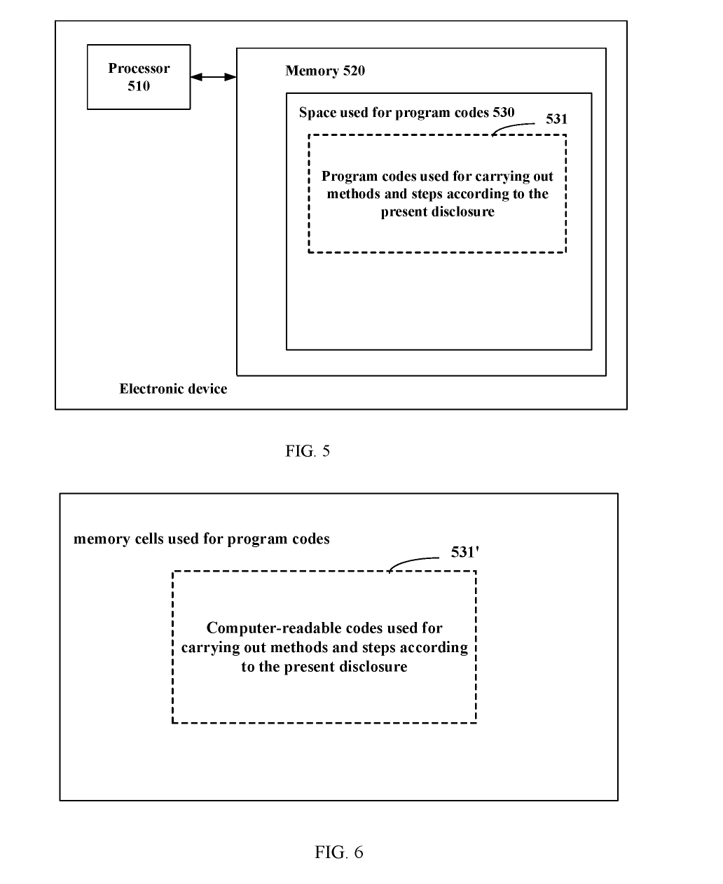

For example, FIG. 5 illustrates a block diagram of an electronic device for executing the method according the disclosure. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the server as shown in FIG. 5. The program codes may be compressed for example in an appropriate form. Usually, the memory cell includes computer readable codes 531′ which can be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described referring to methods, terminal devices (systems) and flow diagrams and/or block diagrams of computer program products according to the embodiments of the present disclosure. It should be understand that each flow and/or each block in the flow diagrams and/or the block diagrams or the combination of flows and/or blocks in the flow diagrams and/or the block diagrams can be realized by computer program commands. The computer program commands can be provided to the processors of general-purpose computers, special-purpose computers, embedded processor or other programmable data processing terminal devices to generate a machine, so as to make the command executed by the processors of computers or other programmable data processing terminal devices generate the device to realize the specified function in a flow or a plurality of flows in the flow diagrams and/or a block or a plurality of blocks in the block diagrams.

The computer program commands can also be stored in a computer readable storage which can guide computers or other programmable data processing terminal devices to work in a specific mode to enable the commands stored in the computer readable storage to generate products including a command device. The command device realizes specified functions in a flow or a plurality of flows in the flow diagrams and/or a block or a plurality of blocks in the block diagrams.

The computer program commands can also be loaded in computers or other programmable data processing terminal devices to enable a series of operating steps to be performed in the computers or other programmable data processing terminal devices to generate the processing realized by computer. Thereby, commands carried out in computers or other programmable data processing terminal devices provide steps to realize specified functions in a flow or a plurality of flows in the flow diagrams and/or a block or a plurality of blocks in the block diagrams.

The control method and the control device for changing brightness provided by the present disclosure are introduced in detail. The principle and the implementation modes of the present disclosure are elaborated with specific examples and the above description of embodiments are only used for facilitating the understanding of the method and the core concept of the present disclosure. Meanwhile, for those skilled in the art, the detailed description of embodiments and the application range can be changed according to the concept of the present disclosure. To sum up, the specification content should not be interpreted as the limit to the present disclosure.

What is claimed is:

1. A control method for changing brightness, comprising:
during a brightness changing process of the display screen, determining a first hardware backlight data before the changing and a second hardware backlight data after the changing according to system brightness before and after the changing;
successively changing the first hardware backlight data according to a unit of the backlight value to update the first hardware backlight data until the first hardware backlight data is updated to the second hardware backlight data; and
successively changing the brightness of the display screen according to the updated first hardware backlight data until the brightness of the display screen reaches the system brightness after the changing.

2. The method according to claim 1, wherein determining a first hardware backlight data before the changing and a second hardware backlight data after the changing according to system brightness before and after the changing comprises:
detecting the current brightness of the display screen to determine the system brightness data before the changing;
mapping the system brightness data before the changing to generate the first hardware backlight data before the changing;
when receiving a brightness changing command, analyzing the command to determine the system brightness data after the changing; and
mapping the system brightness data after the changing to generate the second hardware backlight data after the changing.

3. The method according to claim 1, further comprising:
determining whether the first hardware backlight data before the changing is less than the pre-set flickering threshold value; and
performing the step of successively changing the first hardware backlight data according to the unit of the backlight value when the first hardware backlight data before the changing is less than the pre-set flickering threshold value.

4. The method according to claim 1, wherein successively changing the first hardware backlight data according to the unit of the backlight value comprises:
determining whether the first hardware backlight data is less than the second hardware backlight data;
successively reducing the first hardware backlight data according to the unit of the backlight value when the first hardware backlight data is less than the second hardware backlight data; and
when the first hardware backlight data is not less than the second hardware backlight data, successively increasing the first hardware backlight data according to the unit of the backlight value.

5. The method according to claim 1, wherein successively changing the brightness of the display screen according to the updated first hardware backlight data comprises:
successively storing the updated first hardware backlight data in the register to successively change the brightness of the display screen according to the pre-set delay time value.

6. An electronic device for changing brightness, comprising:
at least one processor; and
a memory communicably connected with the at least one processor for storing instructions executable by the at least one processor, wherein execution of the instructions by the at least one processor causes the at least one processor to:
during the brightness changing process of the display screen, determine a first hardware backlight data before the changing and a second hardware backlight data after the changing according to system brightness before and after the changing;
successively change the first hardware backlight data according to a unit of the backlight value to update the first hardware backlight data until the first hardware backlight data is updated to the second hardware backlight data; and
successively change the brightness of the display screen according to the updated first hardware backlight data until the brightness of the display screen reaches the system brightness after the changing.

7. The electronic device according to claim 6, wherein determine the first hardware backlight data before the changing and the second hardware backlight data after the changing according to the system brightness before and after the changing in the process of brightness change of the display screen comprises:
detect the current display brightness of the display screen, so as to determine the system brightness data before the changing;
map the system brightness data before the changing to generate the first hardware backlight data before the changing
when receiving a brightness changing command, analyze the command to determine the system brightness data after the changing; and
map the system brightness data after the changing to generate the second hardware backlight data after the changing.

8. The electronic device according to claim 6, wherein execution of the instructions by the at least one processor causes the at least one processor to further:
determine whether the first hardware backlight data before the changing is less than the pre-set flicker threshold value and
perform the step of successively changing the first hardware backlight data according to the unit of the backlight value when the first hardware backlight data before the changing is less than the pre-set flicker threshold value.

9. The electronic device according to claim 6, wherein successively changing the first hardware backlight data according to the unit of the backlight value comprises:
determine whether the first hardware backlight data is less than the second hardware backlight data;
successively reduce the first hardware backlight data according to the unit of the backlight value when the first hardware backlight data is less than the second hardware backlight data; and
when the first hardware backlight data is not less than the second hardware backlight data, successively increase the first hardware backlight data according to the unit of the backlight value.

10. The electronic device according to claim 6, wherein successively changing the brightness of the display screen according to the updated first hardware backlight data comprises
successively store the updated first hardware backlight data in the register to successively change the brightness of the display screen according to the pre-set delay time value.

11. A non-transitory computer-readable storage medium storing executable instructions that, when executed by an electronic device with a touch-sensitive display, cause the electronic device to:
during the brightness changing process of the display screen, determine a first hardware backlight data before the changing and a second hardware backlight data after the changing according to system brightness before and after the changing;
successively change the first hardware backlight data according to a unit of the backlight value to update the first hardware backlight data until the first hardware backlight data being updated to the second hardware backlight data; and
successively change the brightness of the display screen according to the updated first hardware backlight data until the brightness of the display screen reaches the system brightness after the changing.

12. The non-transitory computer-readable storage medium according to claim 11, wherein determine a first hardware backlight data before the changing and a second hardware backlight data after the changing according to system brightness before and after the changing comprises:
detecting the current brightness of the display screen to determine the system brightness data before the changing;
mapping the system brightness data before the changing to generate the first hardware backlight data before the changing;
when receiving a brightness changing command, analyzing the command to determine the system brightness data after the changing; and
mapping the system brightness data after the changing to generate the second hardware backlight data after the changing.

13. The non-transitory computer-readable storage medium according to claim 11, wherein the electronic device is further caused to:
determine whether the first hardware backlight data before the changing is less than the pre-set flickering threshold value; and
perform the step of successively changing the first hardware backlight data according to the unit of the backlight value when the first hardware backlight data before the changing is less than the pre-set flickering threshold value.

14. The non-transitory computer-readable storage medium according to claim 11, wherein successively change the first hardware backlight data according to the unit of the backlight value comprises:
determining whether the first hardware backlight data is less than the second hardware backlight data;
successively reducing the first hardware backlight data according to the unit of the backlight value when the first hardware backlight data is less than the second hardware backlight data; and
when the first hardware backlight data is not less than the second hardware backlight data, successively increasing the first hardware backlight data according to the unit of the backlight value.

15. The non-transitory computer-readable storage medium according to claim 11, wherein successively changing the brightness of the display screen according to the updated first hardware backlight data comprises:
successively storing the updated first hardware backlight data in the register to successively change the brightness of the display screen according to the pre-set delay time value.
